(19) United States
(12) Patent Application Publication
(10) Pub. No.: US 2009/0266213 A1
(43) Pub. Date: Oct. 29, 2009

(54) SPLITTING KNIFE ADJUSTMENT STRUCTURE FOR TABLE SAW

(75) Inventors: Chia-Sheng LIU, Taichung County (TW); Yu-Feng Chan, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: DURQ MACHINERY CORP., Shen Kang Hsiang (TW)

(21) Appl. No.: 12/431,871

(22) Filed: Apr. 29, 2009

Related U.S. Application Data
(63) Continuation-in-part of application No. 11/754,469, filed on May 29, 2007, now abandoned.

(30) Foreign Application Priority Data
Jan. 12, 2007 (TW) 96101357

(51) Int. Cl. B26D 5/02; B26D 1/18

(52) U.S. Cl. 83/471.2; 83/477.2

(57) ABSTRACT

A splitting knife adjustment structure used in a table saw for adjusting alignment of a splitting knife with the cutting direction of the saw blade of the table saw is disclosed to include a mounting plate member, an adjustment member supported on the mounting plate member to hold a splitting knife and movable relative to the mounting plate member along an arched path.

### CROSS REFERENCE TO RELATED APPLICATIONS

The present application is a continuation-in-part of U.S. application Ser. No. 11/754,469 entitled SPLITTING KNIFE ADJUSTMENT STRUCTURE FOR TABLE SAW filed on May 29, 2007, the disclosure of which is incorporated herein by reference.

### BACKGROUND OF THE INVENTION

1. Field of the Invention

The present invention relates to table saws and more specifically, to a splitting knife adjustment structure used in a table saw for adjusting alignment of a splitting knife with the cutting direction of the saw blade of the table saw.

2. Description of the Related Art

FIG. 1 shows a conventional table saw 1, which comprises a base 2, a connecting device 3, a saw blade 4, and a splitting knife 5. The connecting device 3 carries the splitting knife 5 to move with the saw blade 4 up and down synchronously. The splitting knife 5 is used to prevent accidental jamming of the cut parts of the workpiece (for example, wooden material) during cutting action of the saw blade 4.

The splitting knife 5 is adapted to provide a safety effect. To achieve this safety effect, the splitting knife 5 must be placed on the extension line L1 of the cutting direction of the saw blade 4, as shown in FIGS. 1 and 2, so that the workpiece can be positively cut without interference by the splitting knife 5. However, in most conditions, the splitting knife 5 may be deviated from the extension line L1 of the cutting direction of the saw blade 4 due to a matching precision problem between the splitting knife 5 and the connecting device 3, or the splitting knife 5 may be hit accidentally by an external force to bias from the extension line L1 of the cutting direction of the saw blade 4. In this case, the cut parts of the workpiece may interfere with the splitting knife 5, endangering workers' safety. Therefore, it is quite important to keep the extending direction of the splitting knife 5 in conformity with the cutting direction of the saw blade 4.

### SUMMARY OF THE INVENTION

The present invention has been accomplished under the circumstances in view. It is the main objective of the present invention to provide a splitting knife adjustment structure for table saw, which allows quick alignment of the splitting knife with the saw blade, assuring smooth and safe cutting operation.

To achieve this objective of the present invention, the splitting knife adjustment structure for a table saw comprises a mounting plate member having an end portion and an arched first surface at the end portion, an adjustment member movably coupled to the end portion of the mounting plate member and having an end portion provided with an arched bearing surface in contact with the arched first surface of the end portion of the mounting plate member, a fixation mechanism adapted to keep the arched first surface of the end portion of the mounting plate member in contact with the arched bearing surface of the end portion of the adjustment member, and a splitting knife fastened to the adjustment member.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a conventional saw blade and splitting knife linking structure in a table saw according to the prior art;

FIG. 2 is a top view of FIG. 1, showing that the splitting knife is offset from the cutting direction of the saw blade;

FIG. 3 is a top view of a splitting knife adjustment structure in a table saw in accordance with a first preferred embodiment of the present invention;

FIG. 4 is an exploded view of the splitting knife adjustment structure in accordance with the first preferred embodiment of the present invention;

FIG. 5 is a schematic drawing of the first preferred embodiment of the present invention, showing that the splitting knife is not in alignment with the cutting direction of the saw blade and is offset outwards;

FIG. 6 is a schematic drawing of a part of the first preferred embodiment of the present invention, showing the position of the adjustment member before action;

FIG. 7 corresponds to FIG. 6, showing the adjustment member moved horizontally inwards relative to the mounting plate member;

FIG. 8 corresponds to FIG. 6, showing the adjustment member moved horizontally outwards relative to the mounting plate member;

FIG. 9 is a schematic drawing of the first preferred embodiment of the present invention, showing that the splitting knife is offset outwards from the cutting direction of the saw blade at an angle;

FIG. 10 is a schematic drawing of a part of the first preferred embodiment of the present invention, showing the position of the adjustment member before action;

FIG. 11 corresponds to FIG. 10, showing the adjustment member turned inwards relative to the mounting plate member;

FIG. 12 corresponds to FIG. 10, showing the adjustment member turned outwards relative to the mounting plate member;

FIG. 13 is a plane view of a part of the first preferred embodiment of the present invention, showing the locating pin fastened to the splitting knife and the connection plate;

FIG. 14 corresponds to FIG. 13, showing the locating pin disengaged from the splitting knife and the connection plate;

FIG. 15 is a schematic drawing of the first preferred embodiment of the present invention, showing that the top of the splitting knife is higher in elevation than the saw blade;

FIG. 16 is a schematic drawing of the first preferred embodiment of the present invention, showing that the top of the splitting knife is located at a same elevation with the saw blade;

FIG. 17 is an exploded view of a part of the first preferred embodiment of the present invention, showing an alternate form of the end panel and the adapter plate;

FIG. 18 is an exploded view of a part of a splitting knife adjustment structure in accordance with a second preferred embodiment of the present invention; and

FIG. 19 corresponds to FIG. 18 showing an alternate form of the end panel and the adapter plate.

FIG. 20 is a schematic side view showing a splitting knife adjustment structure in accordance with a third embodiment of the present invention.

FIG. 21 is a schematic of the splitting knife adjustment structure in accordance with the third embodiment of the present invention, showing the adjustment member biased outwards.

FIG. 22 corresponds to FIG. 20, showing the adapter plate formed integral with the end panel in a single piece.

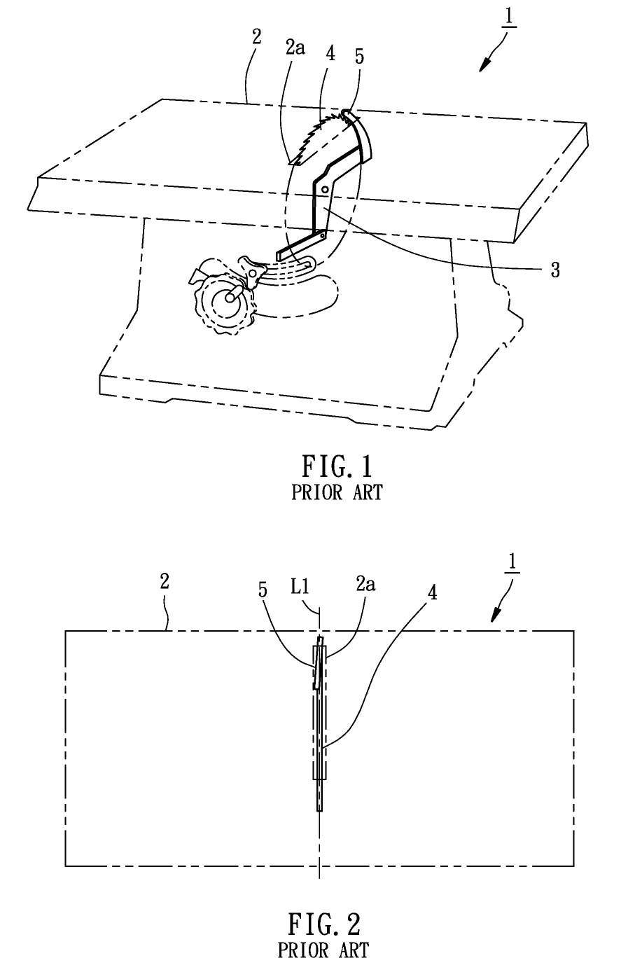

### DETAILED DESCRIPTION OF THE INVENTION

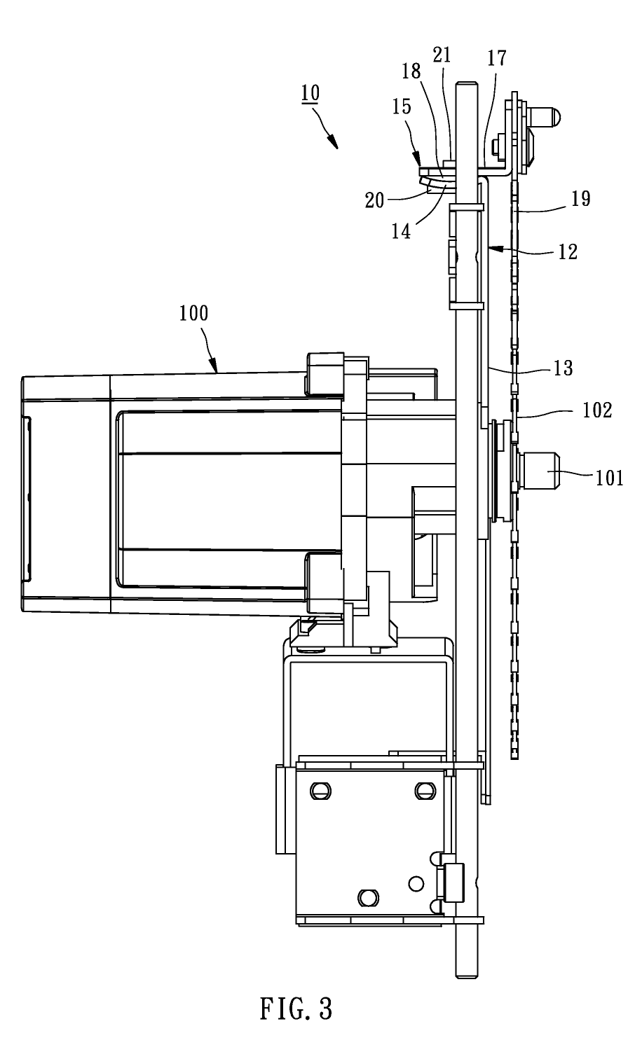

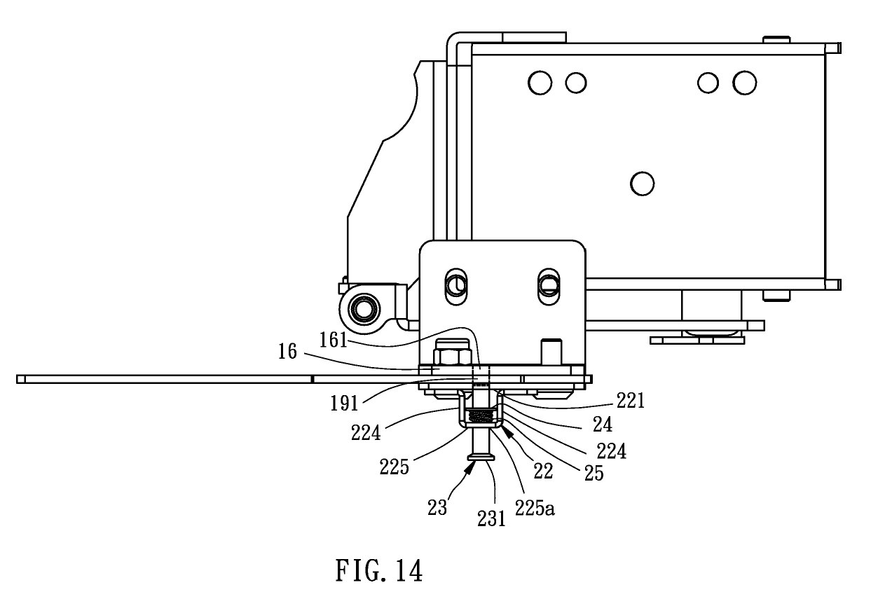

Referring to FIGS. 3-16, a splitting knife adjustment structure 10 in accordance with a first preferred embodiment of the present invention is shown comprising a mounting plate member 12, an adjustment member 15, a splitting knife 19, a fixation member 20, two fastening rods 21, a locating plate 22, a locating pin 23, a retainer ring 24, a spring 25, and two guide members 26.

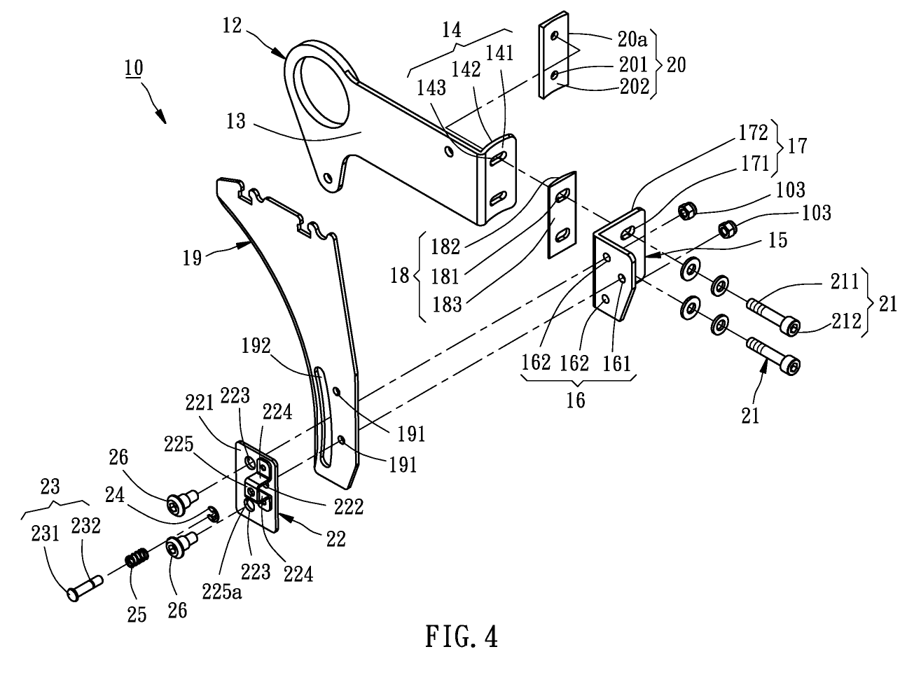

As shown in FIGS. 3 and 4, the mounting plate member 12 has a side panel 13 coupled to the motor output shaft 101 of the table saw 100 and kept in parallel to the saw blade 102, and an end portion formed of an end panel 14 extending from one end of the side panel 13. The end panel 14 has an arched concave surface 141, an arched convex surface 142 opposite to the concave surface 141, and two elongated slots 143 cut through the concave surface 141 and the convex surface 142.

The adjustment member 15 has a connection plate 16, a bearing plate 17, and an end portion formed by an adapter plate 18. Bending a metal plate into shape forms the connection plate 16 and the bearing plate 17. The connection plate 16 is arranged in parallel to the side panel 13 of the mounting plate member 12, having a positioning hole 161 and two guide holes 162. The bearing plate 17 has two elongated through holes 171, and a flat surface 172 facing the concave surface 141 of the end panel 14 of the mounting plate member 12. The adapter plate 18 is set between the end panel 14 of the mounting plate member 12 and the bearing plate 17, having an arched convex surface 182, a flat bearing surface 183 opposite to the convex surface 182, and two elongated through holes 181 cut through the convex surface 182 and the flat bearing surface 183. The convex surface 182 of the adapter plate 18 fits the concave surface 141 of the end panel 14 of the mounting plate member 12. The flat bearing surface 183 of the adapter plate 18 is stopped against the flat surface 172 of the bearing plate 17.

The splitting knife 19 is connected to the connection plate 16 of the adjustment member 15 (this will be described further), having two locating holes 191 and a sliding slot 192.

According to this embodiment, the fixation member 20 and the two fastening rods 21 constitute a fixation mechanism to keep the arched concave surface 141 of the mounting plate member 12 in contact with the convex surface 182 of the adapter plate 18; wherein:

The fixation member 20 has a plate body 20a. The plate body 20a has an arched concave surface 202, and two screw holes 201. The concave surface 202 of the plate body 20a fits the convex surface 142 of the end panel 14 of the mounting plate member 12 so that the fixation member 20 is movable along the arched surface of the convex surface 142 of the end panel 14 of the mounting plate member 12.

The fastening rods 21, which are embodied as screw rods in this preferred embodiment, each have a threaded shank 211 and a head 212 at one end of the threaded shank 211. The threaded shanks 211 of the fastening rods 21 are respectively inserted in proper order through the elongated through holes 171 of the bearing plate 17, the elongated through holes 181 of the adapter plate 18 and the elongated slots 143 of the end panel 14 of the mounting plate member 12 and then respectively threaded into the screw holes 201 of the fixation plate 20, keeping the heads 212 of the fastening rods 21 stopped against the bearing plate 17. Thus, the adjustment member 15 is firmly secured to the mounting plate member 12 to hold the splitting knife 19 in line with the cutting direction of the saw blade 102, as shown in FIG. 3.

Referring to FIGS. 4, 13 and 14, the locating plate 22 has an outer surface 221, an opening 222, two through holes 223, two uprights 224 respectively perpendicularly extending from the outer surface 221, and a top plate 225 integrally connected between the uprights 224 and spaced from the surface 221 at a distance. The top plate 225 has a hole 225a in alignment with the opening 222.

The locating pin 23 has one end inserted through the hole 225a of the top plate 225, the opening 222 of the locating plate 22, one locating hole 191 of the splitting knife 19 and the positioning hole 161 of the connection plate 16, and the other end, namely, the head 231 stopped at the top plate 225. The locating pin 23 further has a locating groove 232 extending around the periphery between its two distal ends.

The retainer ring 24 is a C-shaped retainer fastened to the locating groove 232 of the locating pin 23 and positioned between the top plate 225 and the outer surface 221 of the locating plate 22.

The spring 25 is sleeved onto the locating pin 23 and stopped between the retainer ring 24 and the top plate 225 to impart a biasing force to the locating pin 23, holding the locating pin 23 in the locating hole 191 of the splitting knife 19 and the positioning hole 161 of the connection plate 16.

The two guide members 26 are respectively inserted through the through holes 223 of the locating plate 22 and the sliding slot 192 of the splitting knife 19 and the guide holes 162 of the connection plate 16 and respectively screwed up with a respective nut 103.

After understanding of the assembly and relative positioning of the component parts of the splitting knife adjustment structure 10, the adjustment procedure of the present invention to adjust horizontal displacement and rotation of the splitting knife 19 relative to the saw blade 102 and the adjustment procedure to adjust vertical displacement of the splitting knife 19 relative to the saw blade 102 are described hereinafter.

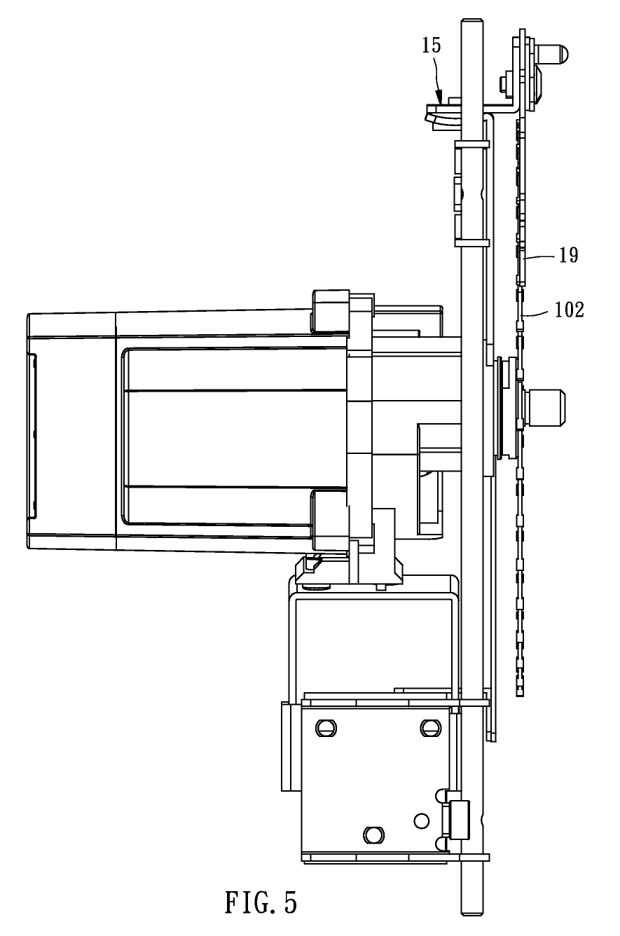

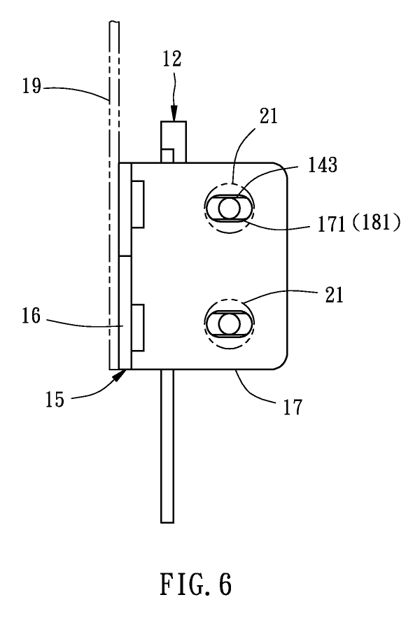

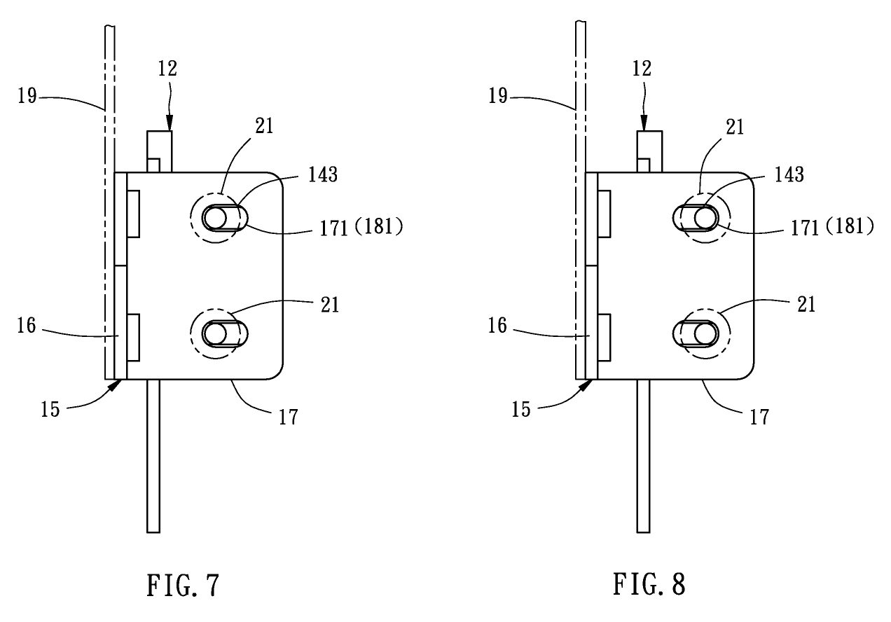

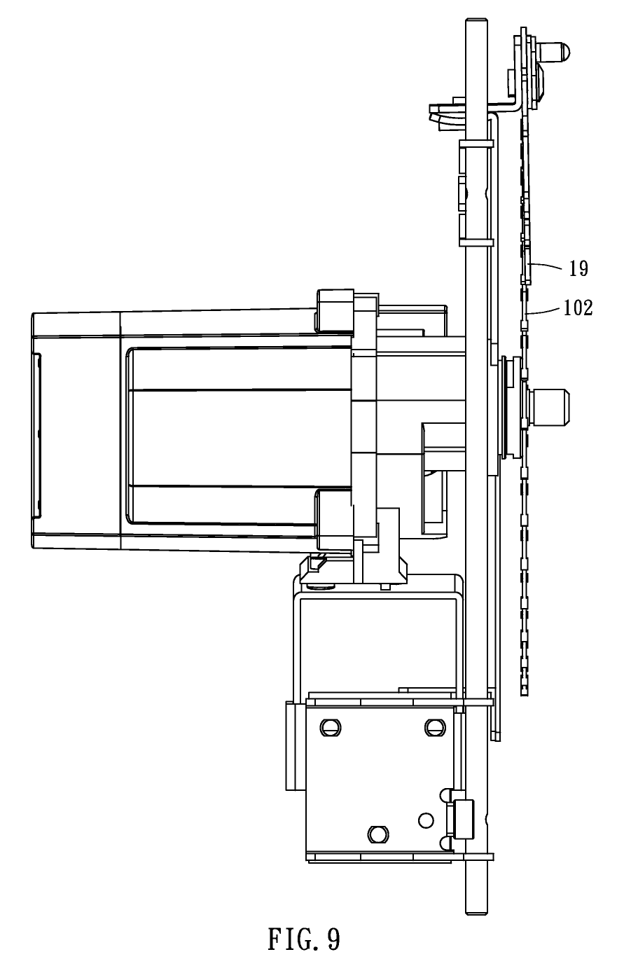

In case the splitting knife 19 is forced by an external factor (for example, impact) to displace outward relative to the saw blade 102 (see FIG. 5) and becomes unable to split the cut parts of the workpiece, an adjustment is necessary. In this case, we can loose the fastening rods 21 and move the adjustment member 15 toward the mounting plate member 12 (see FIGS. 6 and 7) to set the splitting knife 19 into alignment with the cutting direction of the saw blade 102 again, and then fasten tight the fastening rods 21 to fix the splitting knife 19 in position. In case the splitting knife 19 is displaced inward relative to the saw blade 102 and becomes unable to split the cut parts of the workpiece, we can loose the fastening rods 21 and move the adjustment member 15 in direction apart from the mounting plate member 12 (see FIGS. 6 and 8) to set the splitting knife 19 into alignment with the cutting direction of the saw blade 102 again, and then fasten tight the fastening rods 21 to fix the splitting knife 19 in position.

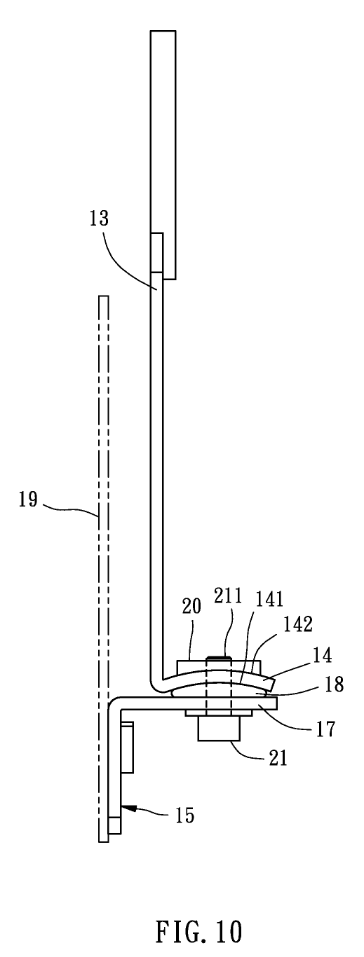

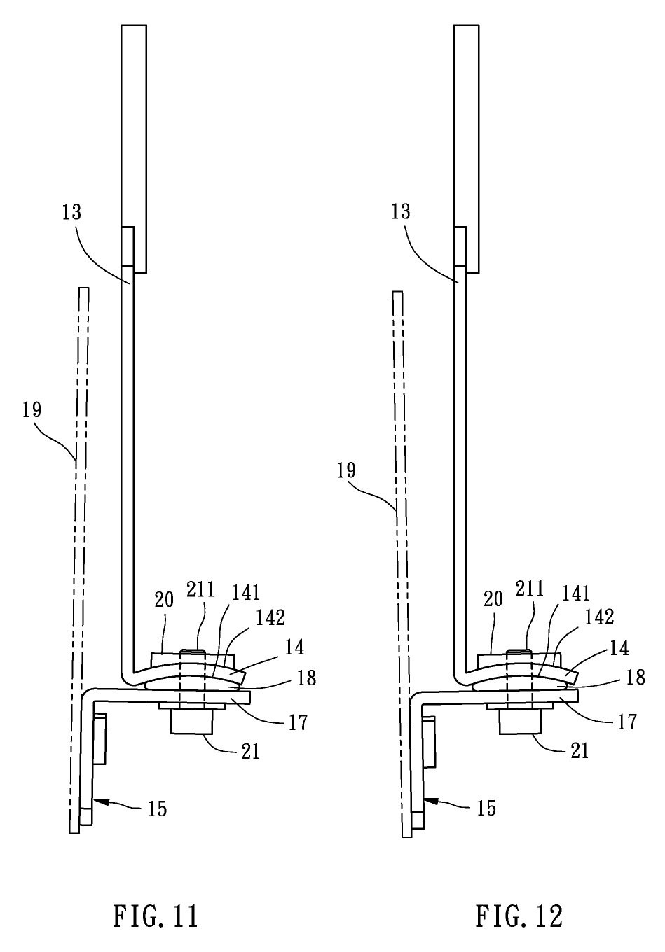

In case the splitting knife 19 is biased horizontally at an angle toward the outer side relative to the saw blade 102 as shown in FIG. 9, an adjustment is necessary. In this case, we can loose the fastening rods 21 slightly and then turn the adjustment member 15 inwards from the position shown in FIG. 10 to the position shown in FIG. 11. At this time, the bearing plate 17 forces the adapter plate 18 to move along the concave surface 141 of the end panel 14 of the mounting plate member 12 in direction apart from the side panel 13, causing the splitting knife 19 to be turned horizontally into alignment with the cutting direction of the saw blade 102, and at the same time the fixation plate 20 is moved along the convex surface 142 of the end panel 14 in direction away from the side panel 13. After fastening up the fixation plate 20 and the fastening rods 21, the adjustment member 15 and the splitting knife 19 are locked in the adjusted position. In case the splitting knife 19 is biased horizontally at an angle toward the inner side relative to the saw blade 102, we can loose the fastening rods 21 slightly and then turn the adjustment member 15 outwards. At this time, the bearing plate 17 forces the adapter plate 18 to move along the concave surface 141 of the end panel 14 of the mounting plate member 12 in direction toward the side panel 13, and at the same time the fixation plate 20 is moved along the convex surface 142 of the end panel 14 in direction toward the side panel 13, causing the splitting knife 19 to be turned horizontally into alignment with the cutting direction of the saw blade 102. After fastening up the fixation plate 20 and the fastening rods 21, the adjustment member 15 and the splitting knife 19 are locked in the adjusted position.

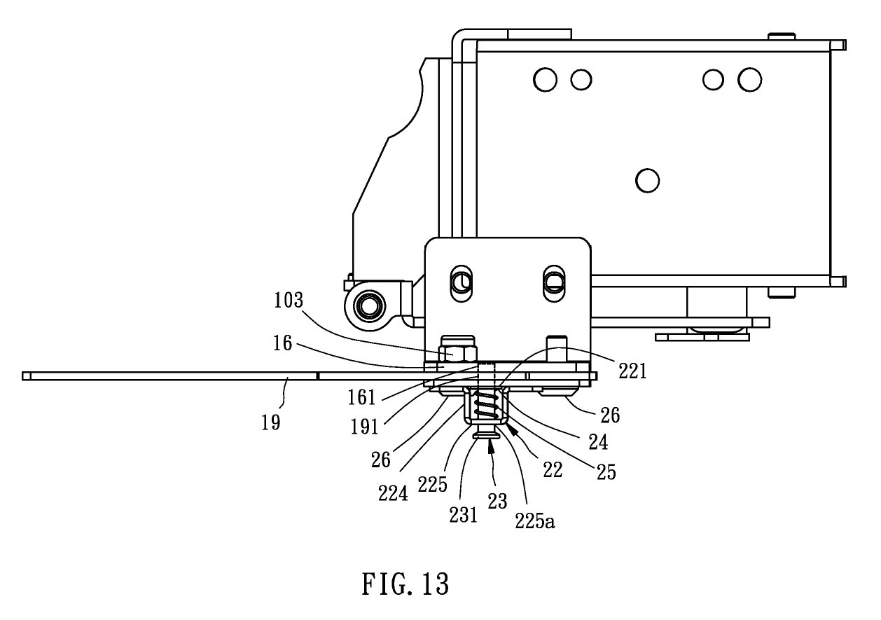

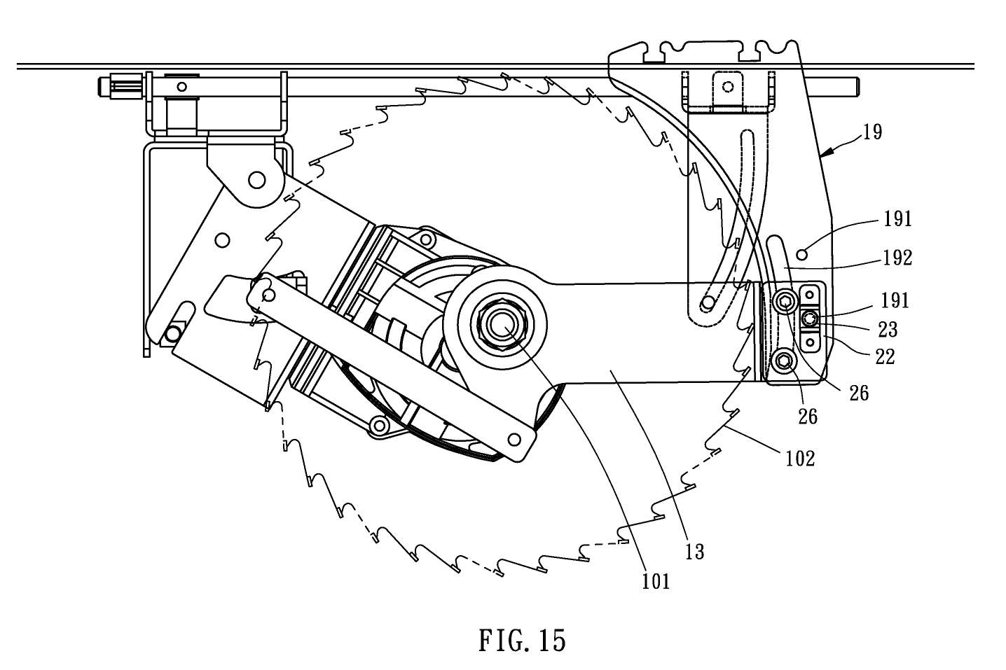

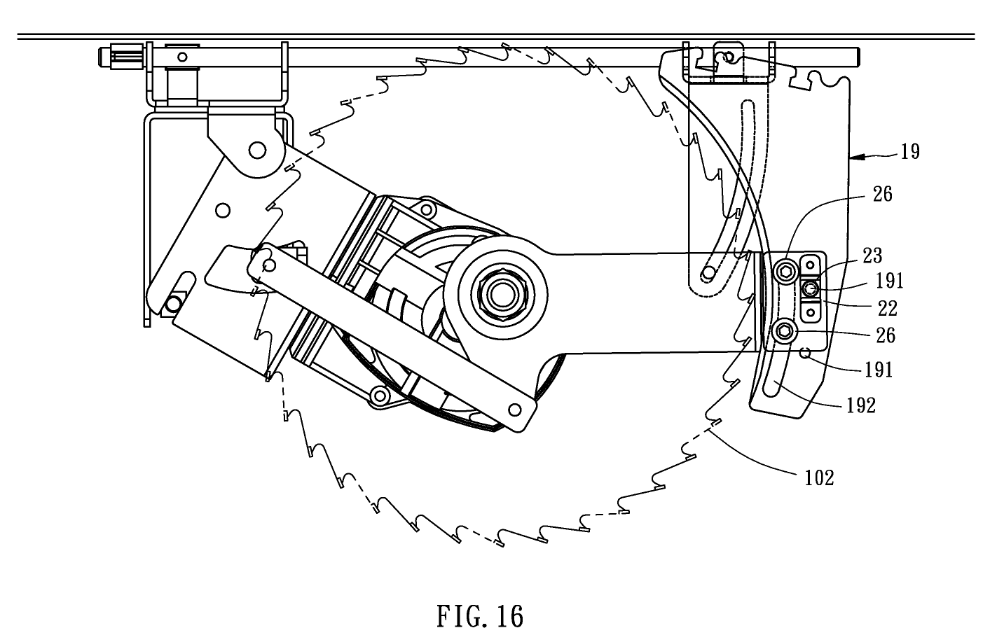

With respect to adjustment of vertical displacement of the splitting knife 19 relative to the saw blade 102, please refer to FIGS. 13, 15 and 16. FIG. 15 shows the bottom end of the sliding slot 192 of the splitting knife 19 stopped at one guide member 26, and the locating pin 23 is kept, subject to the spring force of the spring 25, engaged into the lower locating hole 191 of the splitting knife 19 and the positioning hole 161 of the connection plate 16 (see FIG. 13) to lock the splitting knife 19 in the position above the elevation of the saw blade 102, as shown in FIG. 15. When wishing the adjust the position of the splitting knife 19 from the position shown in FIG. 15 to the position below the elevation of the saw blade 102 as shown in FIG. 16, pull the head 231 of the locating pin 23 outwards against the spring force of the spring 25 to disengage the locating pin 23 from the positioning hole 161 of the connection plate 16 and the lower locating hole 191 of the splitting knife 19, and then pull the splitting knife 19 downwards to have the top end of the sliding slot 192 be stopped at the other guide member 26, and then release the head 231 of the locating pin 23 from the hand for enabling the compressed spring 25 to return to its former shape and to push the locating pin 23 into the upper locating hole 191 of the splitting knife 19 and the positioning hole 161 of the connection plate 16, thereby locking the splitting knife 19 in the adjusted position.

By means of the arched junction between the end panel 14 and the adapter 18, the splitting knife adjustment structure 10 allows rotating adjustment of the position of the splitting knife 19 horizontally; by means of the flat junction between the adapter plate 18 and the bearing plate 17, the splitting knife adjustment structure 10 allows adjustment of horizontal displacement of the position of the splitting knife 19; by means of the arrangement of the locating plate 22 and the locating pin 23, the splitting knife adjustment structure 10 allows adjustment of vertical displacement of the position of the splitting knife 19. Therefore, when the splitting knife 19 is biased or deviated from alignment with the cutting direction of the saw blade 102 due to inaccurate matching of the component parts or an accidental impact, the user can adjust the splitting knife 102 into accurate alignment with the cutting direction of the saw blade 102 conveniently, assuring smooth and safe cutting operation.

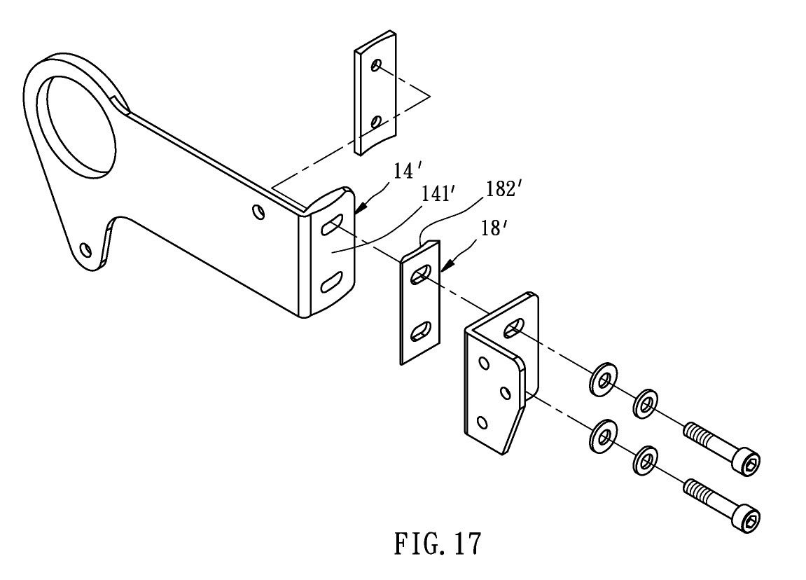

In the aforesaid first embodiment, the concave surface 141 of the end panel 14 of the mounting plate member 12 matches the convex surface 182 of the adapter plate 18 to guide movement of the adapter plate 18 along a smoothly curved track. Alternatively, as shown in FIG. 17, the end panel 14′ can be made having a convex surface 141′ to match the concave surface 182′ of the adapter plate 18.

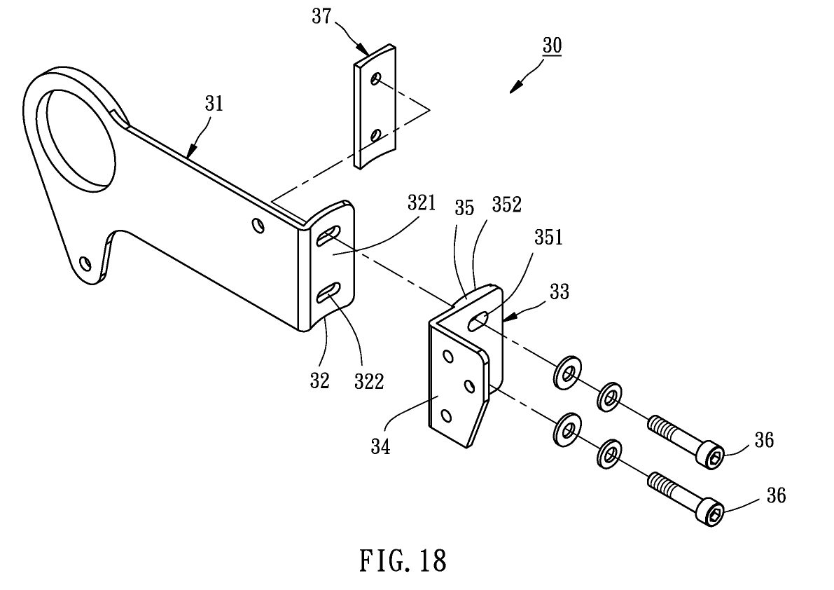

FIG. 18 shows a splitting knife adjustment structure 30 in accordance with a second preferred embodiment of the present invention. Similar to the aforesaid first embodiment, the splitting knife adjustment structure 30 of this second embodiment comprises a mounting plate member 31, an adjustment member 33, two fastening rods 36, and a fixation member 37. Similarly, the mounting plate member 31 has an end panel 32, which has an inner concave surface 321 and two elongated slots 322. The adjustment member 33 is integrally formed with a connection plate 34 and an adapter plate 35. Bending a metal plate into shape forms the connection plate 34 and an adapter plate 35. The adapter plate 35 according to this embodiment is an integrated member of the adapter plate 18 and bearing plate 17 of the aforesaid first embodiment. Further, the adapter plate 35 has two through holes 351, and a bearing surface 352. The bearing surface 352 is a convex surface fitting the concave surface 321 of the end panel 32. By means of the smoothly arched junction between the end panel 32 and the adapter plate 35, the splitting knife adjustment structure 30 allows rotating adjustment of the position of the splitting knife.

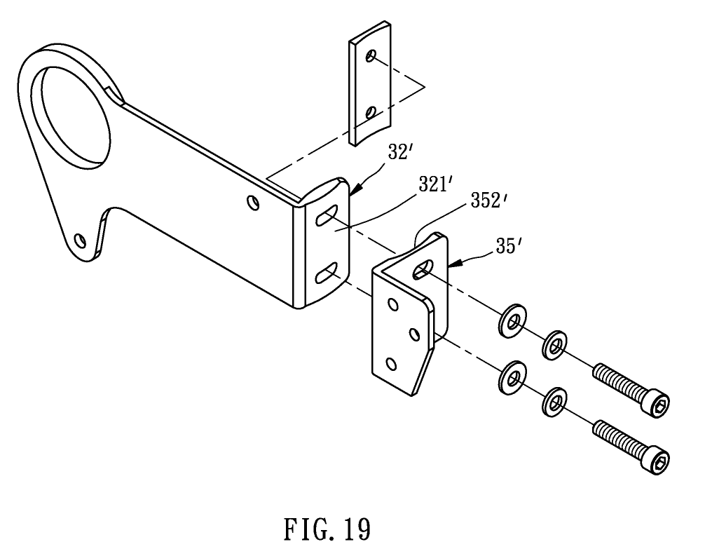

Referring to FIG. 19, the end panel 32′ can be made having a convex surface 321′ to match the concave surface 352′ of the adapter plate 35′. By means of the smoothly arched junction between the end panel 32′ and the adapter plate 35′, rotating adjustment of the position of the splitting knife is allowed.

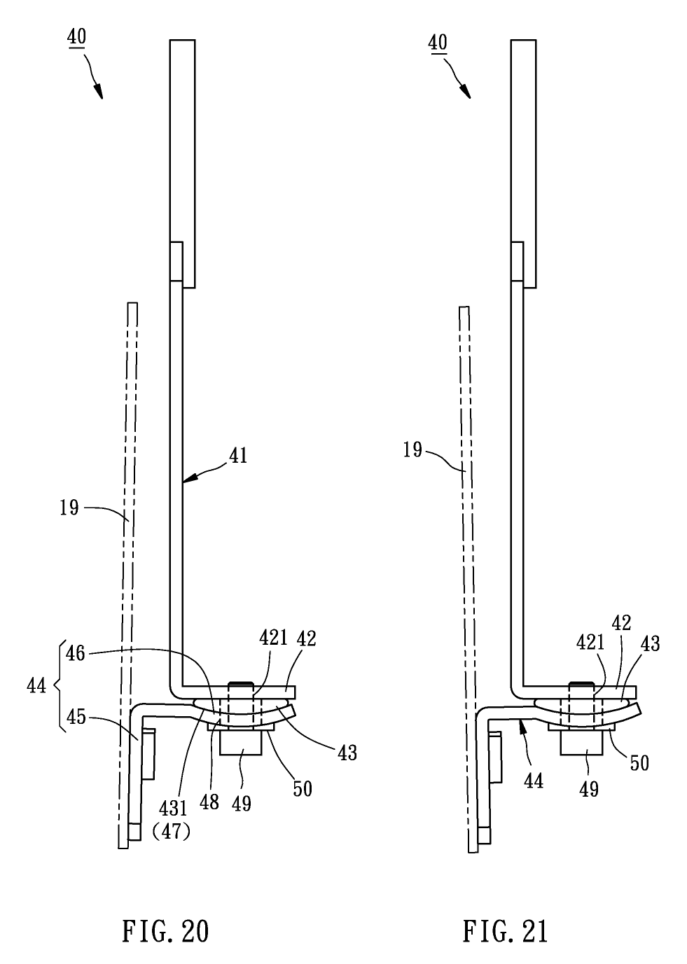

The fixation member 20 in the aforesaid various embodiments may be omitted. FIGS. 20 and 21 show a splitting knife adjustment structure 40 in accordance with a third preferred embodiment of the present invention. According to this third preferred embodiment, the splitting knife adjustment structure 40 comprises a mounting plate member 41, an adjustment member 44, and a fixation mechanism, which is formed of two fastening rods 49, and two soft cushions 50.

The mounting plate member 41 has an end panel 42, and an adapter plate 43 set between the end panel 42 and the adjustment member 44. The end panel 42 has two screw holes 421. The adapter plate 43 forms an end portion of the mounting plate member 41, having an arched convex surface 431.

The adjustment member 44 is an angled plate member, having a connection plate 45 and a bearing plate 46. The connection plate 45 is for the fixation of the splitting knife 19. The bearing plate 46 forms an end portion of the adjustment member 44, having an arched concave surface 47 and two through holes 48.

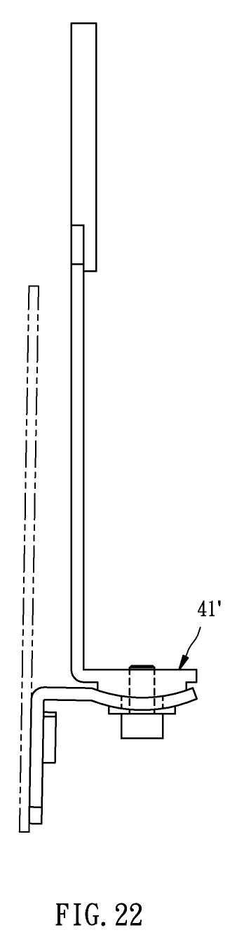

Based on the aforesaid structure, a user can bias the adjustment member 44 outwards to move the splitting knife 19 toward the inside (see FIG. 20), or bias the adjustment member 44 inwards to move the splitting knife 19 toward the outside (see FIG. 21), and then insert the fastening rods 49 through the through holes 48 of the bearing plate 46 and the adapter plate 43, and fastened the fastening rods 49 to the screw holes 421 of the mounting plate member 41 to affix the splitting knife 19 in position. The arrangement of the cushions 50 (between the heads of the fastening rods 49 and the bearing plate 46 of the adjustment member 44) enhances the fixation tightness. The end panel 42 and the adapter plate 43 may be integrally made in a single piece, achieving the same effect. As shown in FIG. 22, the mounting plate member 41′ has the end panel and the adapter plate formed in integrity.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A splitting knife adjustment structure comprising:
a mounting plate member having an end portion, said end portion having an arched first surface;
an adjustment member moveably coupled to the end portion of the mounting plate member, the adjustment member having an end portion provided with an arched bearing surface fitting the arched first surface of the end portion of the mounting plate member;
a fixation mechanism adapted to keep the arched first surface of the end portion of the mounting plate member in contact with the arched bearing surface of the end portion of the adjustment member; and
a splitting knife fastened to the adjustment member.

2. The splitting knife adjustment structure as claimed in claim 1, wherein the mounting plate member has at least one elongated slot cut through the end portion thereof, the adjustment member has at least one through hole cut through the end portion thereof, the fixation mechanism comprises at least one fastening rod having a free end inserted through the at least one through hole of the adjustment member and the at least one elongated slot of the end portion of the mounting plate member, and at least one fixation member fastened to the free end of the at least one fastening rod; the adjustment member comprises an adapter plate, a connection plate and a bearing plate fixedly connected to one end of the connection plate, the adapter plate forming the end portion of the adjustment member and having a first surface forming the arched bearing surface of the end portion of the adjustment member and a second surface opposite to the first surface, the at least one through hole of the adjustment member cutting through the first surface and the second surface of the adapter plate, the bearing plate being supported on the second surface of the adapter plate and having at least one elongated through hole for the passing of the at least one fastening rod, the connection plate being fastened to the splitting knife.

3. The splitting knife adjustment structure as claimed in claim 1, wherein the mounting plate member has at least one elongated slot cut through the end portion thereof, the adjustment member has at least one through hole cut through the end portion thereof, the fixation mechanism comprises at least one fastening rod having a free end inserted through the at least one through hole of the adjustment member and the at least one elongated slot of the end portion of the mounting plate member, and at least one fixation member fastened to the free end of the at least one fastening rod; the adjustment member comprises a connection plate and an adapter plate fixedly extending from one end of the connection plate, the adapter plate forming the end portion of the adjustment member, the adapter plate having a first surface and a second surface opposite to the first surface, the first surface of the adapter plate forming the arched bearing surface of the end portion of the adjustment member, the at least one through hole of the adjustment member cutting through the first surface and the second surface of the adapter plate.

4. The splitting knife adjustment structure as claimed in claim 2, wherein the arched first surface of the end portion of the mounting plate member is a concave surface; the arched bearing surface of the adjustment member is a convex surface fitting the concave surface of the arched first surface of the end portion of the mounting plate member.

5. The splitting knife adjustment structure as claimed in claim 3, wherein the arched first surface of the end portion of the mounting plate member is a concave surface; the arched bearing surface of the adjustment member is a convex surface fitting the concave surface of the arched first surface of the end portion of the mounting plate member.

6. The splitting knife adjustment structure as claimed in claim 2, wherein the second surface of the end portion of the mounting plate member is smoothly arched; the fixation member has a plate body and at least one screw hole formed on the plate body, the plate body having a smoothly arched surface formed on one side thereof fitting the smoothly arched second surface of the end portion of the mounting plate member; the at least one fastening rod each is a screw rod threaded into the at least one screw hole of the fixation member.

7. The splitting knife adjustment structure as claimed in claim 3, wherein the second surface of the end portion of the mounting plate member is smoothly arched; the fixation member has a plate body and at least one screw hole formed on the plate body, the plate body having a smoothly arched surface formed on one side thereof fitting the smoothly arched second surface of the end portion of the mounting plate member; the at least one fastening rod each is a screw rod threaded into the at least one screw hole of the fixation member.

8. The splitting knife adjustment structure as claimed in claim 2, wherein the splitting knife has at least one locating hole; the adjustment member has a positioning hole into which a locating pin that is inserted through the at least one locating hole of the splitting knife is inserted so as to fasten the splitting knife to the adjustment member.

9. The splitting knife adjustment structure as claimed in claim 3, wherein the splitting knife has at least one locating hole; the adjustment member has a positioning hole into which a locating pin that is inserted through the at least one locating hole of the splitting knife is inserted so as to fasten the splitting knife to the adjustment member.

10. The splitting knife adjustment structure as claimed in claim 8, further comprising a locating plate, a retainer ring and a spring member, the locating plate being affixed to the splitting knife and having a top plate spaced from the splitting knife at a distance, the top plate having a hole through which the locating pin is inserted, the retainer ring being fastened to the locating pin and disposed between the top plate and the splitting knife, the spring member being sleeved onto the locating pin and stopped between the top plate and the retainer ring.

11. The splitting knife adjustment structure as claimed in claim 9, further comprising a locating plate, a retainer ring and a spring member, the locating plate being affixed to the splitting knife and having a top plate spaced from the splitting knife at a distance, the top plate having a hole through which the locating pin is inserted, the retainer ring being fastened to the locating pin and disposed between the top plate and the splitting knife, the spring member being sleeved onto the locating pin and stopped between the top plate and the retainer ring.

12. The splitting knife adjustment structure as claimed in claim 2, wherein the arched first surface of the end portion of the mounting plate member is an arched convex surface; the arched bearing surface of the end portion of the adjustment member is an arched concave surface.

13. The splitting knife adjustment structure as claimed in claim 3, wherein the arched first surface of the end portion of the mounting plate member is an arched convex surface; the arched bearing surface of the end portion of the adjustment member is an arched concave surface.

14. The splitting knife adjustment structure as claimed in claim 1, wherein the mounting plate member comprises an end panel and an adapter plate joined to the end panel, the end panel of the mounting plate member having at least one screw hole, the adapter plate forming the end portion of the mounting plate member and defining the arched first surface of the mounting plate member; the fixation mechanism comprises at least one fastening rod, each fastening rod having a free end; the adjustment member has a connection plate and a bearing plate connected to the connection plate at an angle, the bearing plate forming the end portion of the adjustment member and one side thereof forming the arched bearing surface of the adjustment member, the bearing plate being abutted against the arched first surface of the mounting plate member and having at least one through hole; the free end of each fastening rod of the fixation mechanism is respectively inserted through the at least one through hole of the bearing plate of the adjustment member and respectively fastened to the at least one screw hole of the end panel of the mounting plate member; the connection plate of the adjustment member is affixed to the splitting knife.

15. The splitting knife adjustment structure as claimed in claim 14, wherein the end panel and the adapter plate of the mounting plate member are integrally formed in a single piece.

16. The splitting knife adjustment structure as claimed in claim 14, wherein the arched first surface of the end panel of the mounting plate member is an arched convex surface; the arched bearing surface of the end portion of the adjustment member is an arched concave surface.

17. The splitting knife adjustment structure as claimed in claim 15, wherein the arched first surface of the end panel of the mounting plate member is an arched convex surface; the arched bearing surface of the end portion of the adjustment member is an arched concave surface.
